(19) United States
(12) Patent Application Publication
(10) Pub. No.: US 2006/0095761 A1
(43) Pub. Date: May 4, 2006

(54) Selective video encryption method and apparatus

(75) Inventor: Stephen J. Davis, Nepean (CA)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(73) Assignee: Tvidia Corporation, Ottawa, ON (CA)

(21) Appl. No.: 11/255,075

(22) Filed: Oct. 21, 2005

Related U.S. Application Data
(60) Provisional application No. 60/620,693, filed on Oct. 22, 2004.

(51) Int. Cl. H04L 9/00

(52) U.S. Cl. 713/165

(57) ABSTRACT

A method and apparatus of selectively protecting data content, the method having the steps of: selecting content that is to be encrypted; applying an encryption algorithm to content selected in selecting step to create encrypted content; maintaining content not selected in the selecting step in its original format, thereby having unencrypted content; and combining the encrypted content and unencrypted content into a predefined file format for a commercial player.

### FIELD THE INVENTION

The present invention deals with the encryption of data on a physical medium or in a data stream and in particular to the selective encryption of segments of a video stream encoded on a physical medium or that are part of a data stream.

### BACKGROUND TO THE INVENTION

Distribution of data using a physical medium is common and is used for, among other things, the distribution of movies, music, computer programs or data. It is occasionally, however, required that the data on the physical medium be protected in order to restrict unauthorized access to the data.

Prior solutions have, in general, required that the entire physical medium be encrypted and in many cases that the file structure of the physical medium be changed. For example, U.S. Pat. No. 5,796,839 teaches the encryption of a physical medium such as a digital video disc (DVD). The '839 patent teaches the use of encryption keys to encrypt the entire disc where the encryption keys are then stored on a specific location on the physical medium.

One problem with the '839 patent is that the entire disc is encrypted, thereby preventing information that does not need to be protected from being viewed by those without the decryptioning key.

A further problem with prior technologies is that the file system on the physical media is altered in order to provide some protection. For example, U.S. patent application 2002/0112235 to Ballou teaches a system in which movies are distributed on a disc using a non-standard multi-layer DVD format to put multiple movies on a single disc. The format of the discs in Ballou necessitates a proprietary player for reading these discs and without this player a user cannot view any of the contents on the physical medium.

### SUMMARY OF THE INVENTION

The present invention seeks to overcome the deficiencies of the prior art by providing a method and apparatus for selectively encrypting data on a physical medium while leaving the data structure untouched. By providing only selective data encryption, data that the distributor does not want protected can be distributed in an unencrypted format, or encrypted with industry standard means such as the DVD standard Content Scrambling System (CSS) that are unencrypted in standard players, allowing use of the data without a selective encryption key.

In one embodiment of the present invention, a movie can be distributed using a standard DVD format where only portions of the disc are encrypted. Files that remain unencrypted can be viewed in a standard DVD player thereby allowing certain contents to always be viewable. For example, a distributor may wish to protect a movie that is being distributed on a DVD by encrypting the movie but may wish to leave some of the special features and trailers unencrypted and viewable. A user could simply insert the partially encrypted disc into a standard DVD player and could view these special features or trailers without the need for an decryption key. The subsequent obtaining of an decryption key could then allow the user to view the encrypted portion of the DVD.

As will be appreciated by those skilled in the art, selective encryption of content does not precludes the use of standard encryption mechanisms such as CSS. As used herein, unencrypted means no encryption beyond what would normally be present on the medium has been added.

The above is meant to be merely an example, and the present invention is not meant to be limited solely to digital video discs or movies, but could apply equally to downloaded content or content distributed on other storage media.

### BRIEF DESCRIPTION OF THE DRAWINGS

The present invention with reference to the drawings in which:

FIG. 1 is a screen capture for a file format on a digital video disc;

FIG. 2 is a flow chart of a system and method for selected encryption; and

FIG. 3 is a flow chart of an example decryption technique system according to the present invention.

### DETAILED DESCRIPTION OF THE DRAWINGS

The present invention deals with the select encryption of various digital media. This can include, but is not limited to, digital video discs (DVDs), compact discs (CDs), digital audio tapes (DAT) or any other physical digital media. Further, the present invention could apply equally to downloaded content. In the examples below, digital video discs (DVD) will be used for illustrative purposes only and this is not meant to be limiting to the present invention.

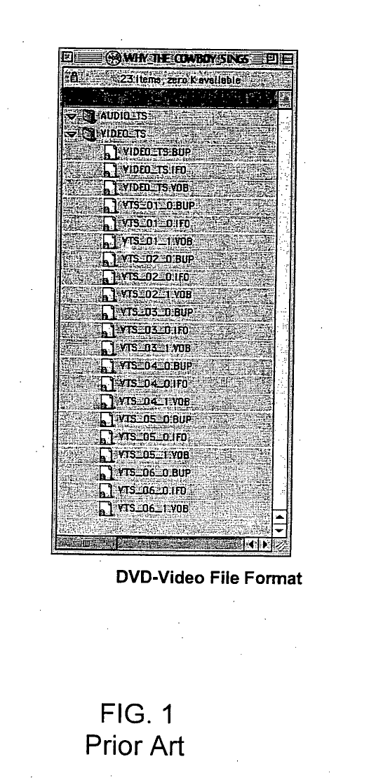

References made to FIG. 1, a physical medium such as a DVD includes standards for the creation of a file structure and methods of organizing the data in order to be played or retrieved on a standard player. If the physical medium does not contain a file or data structure that meets the specifications, the player will fail to read and display the contents of the physical medium. Media compatibility is an important aspect for a content protection system and according to the present invention the compatible media format should always be maintained.

The present invention will be illustrated by example of a DVD. FIG. 1 shows a DVD file structure includes various folders and files. These include an audio title set folder labelled as AUDIO_TS. The AUDIO_TS folder is a part of the original DVD-video specification and is not populated with files in a DVD-video disc. DVD authoring software packages still generate this folder. It is used primarily in the DVD-audio disc format.

The VIDEO_TS folder is the video title set folder. This folder must be used at the top of root directory level of the DVD. Other files and folders may exist at the root level and, are related to enhanced features provided on the disc making the disc a ‘hybrid’ DVD.

The VIDEO_TS folder contains the various titles sets (VTS) for a DVD-video. A VTS represents a ‘title’ which is a movie or a track on a DVD-video.

The VIDEO_TS folder also contains information about the navigation structure for the disc and its menus/scripting. This folder can contain many video title sets where one video title set usually represents the main movie while other video title sets represent supplementary materials, movie trailers, filmographies, etc.

The video title set consists of three files which are the VOB, IFO and BUP files.

The VOB file of a video title set contains the multiplex menus, audio, video and subtitle streams for a title. These are the presentation or displayed contents for a DVD-video. Under normal conditions, one cannot de-multiplex the menus, audio, video and subtitle streams in order to deconstruct or change the content. Re-authoring and re-multiplexing is required.

The VOB can be no larger then one gigabyte and spills over into another VOB of another video title set if necessary.

The IFO files are navigation files and contain navigation instructions, including jumps, programs and button definitions. This file also contains the set up options such as aspect ratio and language selection. An IFO can be no larger then one gigabyte and spills over into another IFO of another VTS if necessary.

The BUP files are back up files of the video title set and are a duplicate of the IFO file for that set. This duplicate is used avoid data being lost through scratches or errors in the DVD-video disc. The BUP is usually physically located in the outer rings of the DVD, far from the original.

A standard DVD player will require that the above format be maintained in order to play the contents of a DVD.

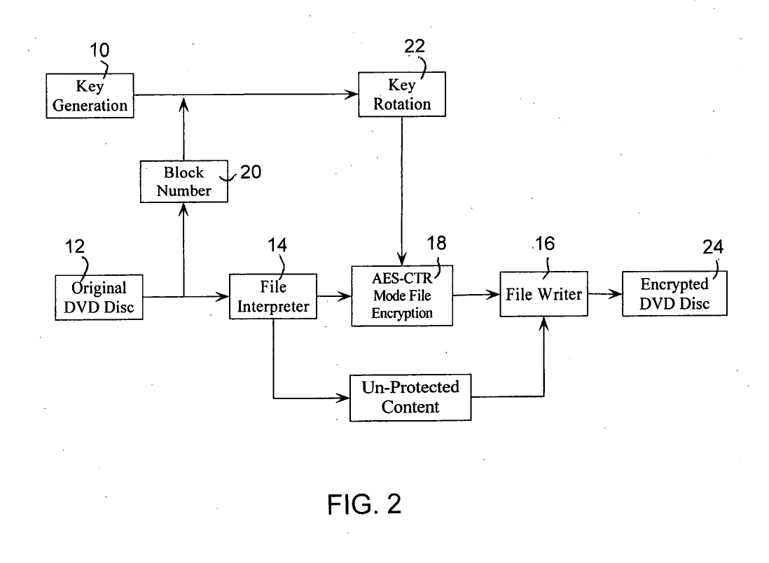

Reference is now made to FIG. 2. FIG. 2 shows a selected encryption method according to the present invention in which the key generation step 10 is used to generate a disc key. This disc key will be used as part of the content encryption key to protect the selected content. A unique identifier is linked to this disc key to allow key retrieval from a key module. The unique identifier is placed in a special file on the encrypted media. In the preferred embodiment the identifier is placed in a special file called UID.dat in the base directory of the DVD.

An original DVD file is used in step 12 to source Universal Disk Standard (UDF) blocks which are sent to a file interpreter 14, as is known to those skilled in the art. A file interpreter 14 accesses each file on the DVD and searches for the selected content that is to be protected.

When content that is to be protected is located by file interpreter 14, this module provides a file number and a block number for use as a counter for the encryption. In a preferred embodiment, encryption is done using the AES-128 algorithm, as is described by the National Institute of Standards and Technology in the Advanced Encryption Standard Federal Information Processing Standards, publication 197. This algorithm is approved by NIST as the primary encryption algorithm of the U.S. government and can be used in counter mode which provides the capability of random access to content.

The AES 128 algorithm is preferably a counter mode encryption or AES-CTR mode. This allows for the decryption of blocks based on a block number without the requirement that all previous block numbers be decrypted prior to the decryption of the desired block. As one skilled in the art will appreciate, this presents the advantage that content can be decrypted in any order during play back and that decryption can occur for the block that the user is currently viewing.

Referring again to FIG. 2, unprotected content from file interpreter 14 is passed directly to a file writer 16. The unprotected content can be anything that content owner or distributor does not need protection for. This can include trailers, audio, special features or other aspects including parts of the movie.

In one aspect of the present invention, it is preferred that only the movie portion of the DVD be protected, leaving the IFO and BUP files, as well as the audio, subtitle content and even “special features” unencrypted. In this fashion the DVD will continue to function even without access to the actual video content. Navigation and menus will continue to function and will not be involved in the custom decryption of the content. It is anticipated that some DVDs will be augmented with special video content that can be displayed by customized DVD players or customized software codecs when encrypted content is accessed without proper selective encryption keys. This content would provide warnings and information regarding the encrypted state of the accessed content.

Content that is to be protected is passed from file interpreter 14 to an encryption block 18. Each block of the data is then encrypted using AES-CTR mode encryption and passed to file writer 16 for writing it back to the modified file. Encryption occurs by having file interpreter 14 pass a block number 20 to key rotation 22. Key rotation 22 generates an encryption key based on the block number and disc key. Encryption block 18 uses the key generated in key rotation 22 to encrypt the blocks that are then sent to file writer 16.

Once file writer 16 receives both the unencrypted and encrypted content, it writes these blocks into a final encrypted DVD disc 24. As will be appreciated by one skilled in the art, encrypted DVD disc 24 could include an encrypted master for stamping or could be an individual disc for distribution.

As will be further appreciated by those skilled in the art, the above will not change the resulting size of the DVD. The format of the VOB file is also not changed. This removes the need to change chaptering information of the DVD since the file sizes are not changed, new information is not added, and files are not moved around.

Each block written onto encrypted DVD disc 24 using file writer 16 is a UDF block with a standard format. As will be known to those skilled in the art, data streams exist as part of a UDF block or could span across 2 or more UDF blocks. Each data stream includes a header that can be used to mark the type of stream. One type of marking indicates that the stream is private. The stream identifier on the DVD for encrypted streams is changed to ensure that consumer DVD players do not try to interpret encrypted DVD video data.

CSS encryption, which is the protection for DVDs, will need to be removed by file interpreter 14 and added again by file writer 16. In this way the CSS protection remains on the disc and the disc is readable by a standard DVD player. Further, by marking each stream as private, when the stream is demultiplexed it will be viewed as private by the reader and, if the reader is an intelligent reader, passed to a decryption module as is explained in more detail below. The decryption module (as described in more detail below) must be activated by a selective decryption key stored in a hardware or software based database. In the absence of this selective decryption key the content will not be decrypted and will not progress any further through the decoding path.

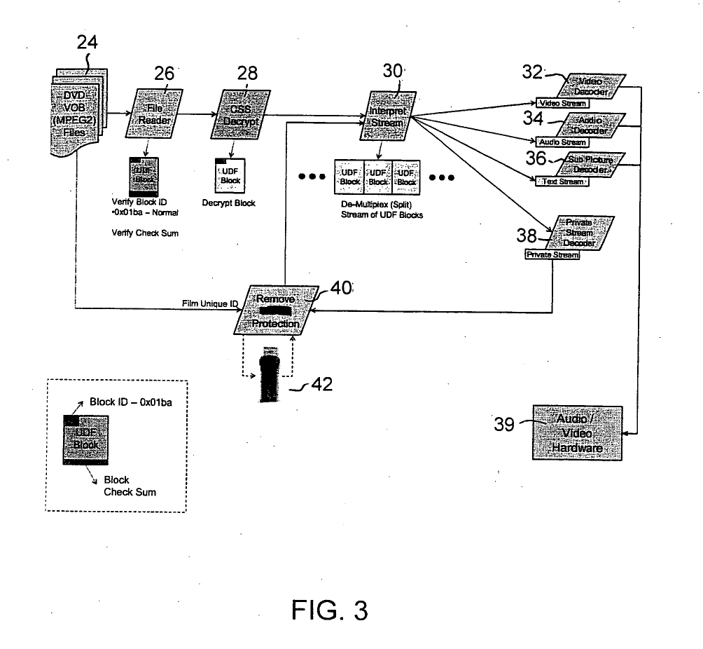

Reference is now made to FIG. 3. FIG. 3 shows one method of decryption for a physical medium that is selectively encrypted. A selectively encrypted physical medium 24 is inserted into a player. The player includes a file reader and a CSS decryption module 26 and 28 respectively. File reader 26 extracts blocks of data that are 2048 bytes long, knows as UDF blocks. These blocks are tagged and with DVDs are in MPEG2 format. In CSS decrypt block 28 the CSS encryption is removed from the files which produces a decrypted UDF block. This decrypted UDF block is then passed to an interpret stream module 30.

Interpret stream module 30 extracts streams of data from UDF blocks and builds them into variable length streams. Demultiplexing of a stream is known to those skilled in the art.

Based on the type of stream, interpret stream block 30 then passes the stream to either the video decoder 32 if the stream is a video stream, audio decode 34 if the stream is an audio stream, subpicture decoder 36 if the stream is a text stream or a private stream decoder 38 if the stream is marked as a private stream.

Video decode 32, audio decoder 34 and subpicture decoder 36 then pass the output to audio video hardware 39 which a can be a television receiver, stereo receiver/amplifier or other output devices known to those skilled in the art.

Private stream decoder 38 passes its private stream to a decryption module 40 in order to remove encryption on that stream. As indicated above each physical medium has a unique identifier that is associated with the key for that physical medium and this unique identifier is passed from the encrypted DVD 24 to the decryption module 40 in order to allow decryption module 40 to decrypt the stream passed to it. Decryption module 40 may further have a key module 42 that can be internal or external to associate the unique identifier with the decryption key required to decrypt the stream.

As will be appreciated by one skilled in the art, decryption could further occur in an external key module 42 to prevent a key from ever being passed out of media key 42.

Once the private stream from private stream decoder 38 is decrypted in decryption module 40, it is passed back to the stream interpreter 30 which then passes the decrypted stream to either video decoder 32, audio decoder 34 or subpicture decoder 36 depending on the type of the decoded stream. This decoded stream is then passed to audio video hardware 39.

As will be appreciated by those skilled in the art, streams are typically buffered in order to provide smooth run time. Thus the decryption could occur with the stream still being placed in its correct position within the output to audio video hardware 39.

As will be appreciated by one skilled in the art, other media (such as, but not limited to, CDs, USB Memory, Compact Flash Memory) have formats (such as, but not limited to, MPEG4, WMA, WM10, AAC) that need to be adhered to in order to allow a standard player to read the media. The above could be translated to other media ensuring that the file format and structure of the media remain the same while allowing for the selective encryption of portions of the data on the media.

The present system and method therefore provides a way to selectively encrypt portions of data on a physical medium where a standard reader can view the remainder of data on the physical medium. Only the encrypted portions need a key module to decrypt them. The other portions of the data or the medium are viewable regardless of whether a user has a key.

Alternatively, as indicated above, the present method could apply equally to the downloading of data. In this case, the data is expected in a specific format in order to properly be played on the downloading hardware. This format should not be changed, since this would require changes in the hardware or software of the player.

The complete encryption of a download stream can be cumbersome for some devices that do not have heavy computational resources. Examples include cellular telephones or other mobile devices, in which the computational resources required to decrypt an entire media stream might not be present.

The present method could therefore be used to selectively encrypt content on a frame level by only encrypting selected frames. In one embodiment, one out of ten frames could be encrypted. This would make the steam to the phone unplayable but would only require the processor to use ten percent of the computational resources to decrypt when compared with a fully encrypted video stream.

Further, as with the above, a content distributor may wish to distribute content where a portion such as a video trailer or a music sample are unencrypted and playable in order to entice a consumer to purchase the decryption key. This again could be accomplished with the present method.

For downloads, as will be appreciated by those skilled in the art, the method could be used for both streaming downloads to the playback device or for downloads which are then stored on a local physical medium for future playback. These devices could include mobile devices, personal computers, smart appliances such as DVD players with communication means, satellite boxes, cable boxes or other physical players known to those skilled in the art.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method of selectively protecting data content comprising the steps of:
a. selecting content that is to be encrypted;
b. applying an encryption algorithm to content selected in selecting step to create encrypted content;
c. maintaining content not selected in said selecting step in its original format, thereby having unencrypted content; and
d. combining said encrypted content and unencrypted content into a predefined file format for a commercial player.

2. The method of claim 1, wherein said applying step applies an encryption key to said content.

3. The method of claim 2, wherein said encryption key is determined based on a block number of said content.

4. The method of claim 1, wherein said method further comprises the step of writing encrypted content and unencrypted content onto a physical medium.

5. The method of claim 4, wherein said physical medium is selected from the group consisting of a digital video disc, a compact disc and a digital audio tape.

6. The method of claim 5, wherein said predefined file format is a standard for one of the digital video disc, the compact disc and the digital audio tape.

7. The method of claim 5, wherein if said physical medium is a digital video disc, said method further comprises the step of applying a content scrambling system to said encrypted content and unencrypted content after said combining step and before said writing step.

8. The method of claim 1, wherein said method further comprises the step of downloading said encrypted content and said unencrypted content combined in said combining step to a player.

9. The method of claim 8, wherein said downloading step allows for streaming of said unencrypted content combined in said combining step.

10. The method of claim 8, wherein said downloading step allows for storage of said unencrypted content combined in said combining step for future playback.

11. The method of claim 8, wherein said player is selected from the group consisting of a mobile device, a personal computer, a satellite box, a cable box, and a player with communication means.

12. A data storage medium with a predetermined file structure, the medium comprising:
a. storage means, the storage means adapted to store:
i. selectively encrypted files; and
ii. decrypted files,
wherein the predetermined file structure is not altered by said selectively encrypted files.

13. The data storage medium of claim 12, wherein the physical medium is selected from the group consisting of a digital video disc, a compact disc and a digital audio tape.

14. An apparatus for the selective encryption of content, said apparatus comprising:
a. a file interpreter, said file interpreter adapted to receive unencrypted content and select content for encryption;
b. an encryption module, said encryption module adapted to encrypt content selected by said file interpreter for encryption; and
c. a file writer, said file writer adapted to receive encrypted content from said encryption module and unencrypted content from said file interpreter and to combine the content into a predefined file format.

15. The apparatus of claim 14, further comprising a key rotation means, said key rotation means adapted to select a key based on a block of content and provide the key to said encryption module.

16. The apparatus of claim 14, further comprising a writing module, said writing module adapted to accept combined content in the predetermined file format and write the content onto a physical medium.

17. The apparatus of claim 16, wherein said physical medium is selected from the group consisting of a digital video disc, a compact disc and a digital audio tape.

18. The apparatus of claim 14, further comprising a communications module, said communications module adapted to accept combined content in the predetermined file format and send the content to a player.
